(19) United States
(12) Patent Application Publication
(10) Pub. No.: US 2011/0127102 A1
(43) Pub. Date: Jun. 2, 2011

(54) TWO-SHAFT SHIFT TRANSMISSION OF A MOTOR VEHICLE

(75) Inventors: Eckhard KIRCHNER, Ginsheim (DE); Christian KUNZE, Gross-Gerau (DE)

(73) Assignee: GM GLOBAL TECHNOLOGY OPERATIONS, INC., Detroit, MI (US)

(21) Appl. No.: 12/954,173

(22) Filed: Nov. 24, 2010

(30) Foreign Application Priority Data
Nov. 27, 2009 (DE) 102009056045.9

(51) Int. Cl. B60K 17/08; F16H 3/44

(52) U.S. Cl. 180/369; 475/296

(57) ABSTRACT

A two-shaft shift transmission is provided for a vehicle. The two-shaft shift transmission has a drive shaft and an output shaft. Drive gearwheels for forward gears (G1 to G6) and a drive gearwheel for a reverse gear (R) are situated on the drive shaft. Output gearwheels for forward gears (G1 to G6) and an output gearwheel for the reverse gear (R) are situated on the output shaft. Shift elements engage drive gearwheels with output gearwheels in pairs via synchronous clutches. The two-shaft shift transmission has a planetary gearing, which can be engaged via a double clutch with the drive shaft of the two-stage transmission. Each gearwheel pair made of a drive gearwheel and output gearwheel transmits torques of two forward gears (G1 to G6).

### CROSS-REFERENCE TO RELATED APPLICATION

This application claims priority to German Patent Application No. 102009056045.9, filed Nov. 27, 2009, which is incorporated herein by reference in its entirety.

### TECHNICAL FIELD

The technical field relates to a two-shaft shift transmission of a motor vehicle. The technical field also relates to a two-shaft shift transmission for a vehicle. The two-shaft shift transmission has a drive shaft and an output shaft. Drive gearwheels for four forward gears and one drive gearwheel for a reverse gear are situated on the drive shaft. Output gearwheels for forward gears and one output gearwheel for the reverse gear are situated on output shaft. Shift elements engage drive gearwheels with output gearwheels in pairs via synchronization.

### BACKGROUND

A multi-shaft shift transmission 3 for six forward gears G1 to G6 and one reverse gear R having a double clutch 20 is shown according to the prior art in FIG. 3. In a first clutch stage 21, the double clutch 20 connects a central drive shaft 4 to an output shaft 31 of the drive motor via a first clutch plate 23. For this purpose, the first clutch stage 21 has a first clutch pack 25, which connects the clutch housing 52, which is connected in a rotationally-fixed manner to the output shaft 31 of the engine, to the first clutch plate 23 and thus to the central drive shaft 4. Only two output gearwheels 43 and 44 are situated on this central drive shaft 4, which mesh with the output gearwheels 47 and 49 of the forward gears 1 and 3 and produce the traction between central drive shaft 4 and output shaft 5 via a synchronous clutch 15a on the output shaft 5.

In addition to these two gearwheel pairs for the first and the third forward gears, output gearwheels 48 and 51 are also situated on the output shaft 5, using which the forward gears 2 and 4 may also be engaged via a synchronous clutch 15b. However, these output gearwheels 48 and 51 mesh with drive gearwheels 45 or 46, respectively, of a hollow shaft 50, which, after disengaging the first clutch stage 21 and engaging the second clutch stage 22, connect the hollow shaft 50 having its two drive gearwheels 45 and 46 to the output shaft 31 of the vehicle engine via the second clutch plate 24 with the aid of the second clutch pack 26.

Not only the output gearwheels 48 and 51 of the forward gears 2 and 4 mesh with the hollow shaft 50 and its two drive gearwheels 45 and 46, but rather also coupling gearwheels of a coupling shaft 53, namely one coupling gearwheel 54 of the reverse gear R, one coupling gearwheel 55 of the sixth forward gear G6, which may be coupled with the coupling shaft 53 with the aid of a synchronous clutch 16b, and additionally one coupling gearwheel 56 for the fifth forward gear G5, which meshes with a gearwheel 57, which is connected in a rotationally fixed manner to the central drive shaft 4, via a further at least single-sided synchronous clutch 16a. Accordingly, for this six-gear transmission 40 having double clutch 20, four synchronous clutches 15a, 15b, 16a, and 16b are required for shifting, and additionally four shafts are required, namely a drive shaft 4, an output shaft 5, a hollow shaft 50, and a coupling shaft 53, which is technically connected to a large space requirement and high costs.

A six-gear transmission having double clutch is known from WO 2008/124001 A1, which also has a central drive shaft having two drive gearwheels, which are directly connected to the central drive shaft, and a hollow shaft, which has three drive gearwheels, these five drive gearwheels being able to mesh or be engaged with gearwheels of an output shaft, a planetary gearing being provided on one end of the output shaft in each case, which allows six forward gears, one reverse gear, and a parking position for the transmission to be provided with the aid of four synchronous clutches acting on both sides.

In view of the foregoing, at least one object is to provide a six-gear transmission having a two-stage clutch, which only has one drive shaft and one output shaft, both the number of the gearwheel pairs and also the number of the synchronous clutches being reduced. In addition, other objects, desirable features and characteristics will become apparent from the subsequent detailed description, and the appended claims, taken in conjunction with the accompanying drawings and this background.

### SUMMARY

A two-shaft shift transmission is provided for a vehicle. The two-shaft shift transmission has a drive shaft and an output shaft. Drive gearwheels for forward gears and a drive gearwheel for a reverse gear are situated on the drive shaft. Output gearwheels for forward gears and an output gearwheel for the reverse gear are situated on output shaft. Shift elements engage drive gearwheels with output gearwheels in pairs via synchronous clutches. The two-shaft shift transmission has a planetary gearing, which can be engaged with the drive shaft of the two-stage transmission via a double clutch. Each gearwheel pair made of drive gearwheel and output gearwheel transmits torques of two forward gears.

This six-gear transmission having an additional reverse gear has the advantage of a cost-effective and space-saving solution. A first gearwheel pair for the first and second gears is driven by the coupling of the drive shaft to a planetary gearing, whose sun wheel is situated on the drive axle and allows a first speed for the first forward gear when a first stage having a first clutch plate of a double clutch is connected to an output shaft of an engine. If the second stage of the clutch is actuated, the planet wheels of the planetary gearing are connected to the output shaft of the engine via a second clutch plate and mesh with the sun wheel, so that the sun wheel rotates at a higher speed for the second forward gear and transmits a higher speed via the same gearwheel pair of the first gear to the output shaft.

A second gearwheel pair operates the third and fourth gears accordingly, i.e., via the sun wheel of the planetary gearing or via the planet wheels of the planetary gearing, respectively, which connect the drive shaft of the transmission to the output shaft of the engine in the respective clutch stage via the associated clutch plates. Finally, a third gearwheel pair operates the fifth forward gear and the sixth forward gear depending on the engagement of the first or the second stage of the double clutch, respectively.

In the planetary gearing, the transmission ratio of the planetary gearing defines the ratio of the change between the adjacent gears ½, 2/4, and ⅚ of the two-shaft shift transmission. An improvement of the spatial conditions through the use of the planetary gearing in a first end area of the drive shaft in relation to the double clutch is advantageous over typical six-gear transmissions having two planetary gearings on the output shaft, for example. Together with the gearwheel pair for the reverse gear, only four gearwheel pairs are thus provided for a six-gear transmission having reverse gear.

In addition, the number of the synchronous clutches is significantly reduced, since only two synchronous clutches are required for shifting between the four gearwheel pairs. The number of the synchronous clutches is practically reduced by half in relation to the prior art described in the introduction. The drive shaft and the output shaft are thus advantageously shortened. For this purpose, it is only necessary to provide two actuators, which are locked separately from one another, for the double clutch and a planetary gearing.

These advantages are achieved in that the first clutch stage cooperates with a first clutch plate, the first clutch plate connecting a central sun wheel of the planetary gearing to the output shaft of the engine. A second clutch stage additionally cooperates with a second clutch plate, the second clutch plate connecting the planet wheels of the planetary gearing to the output shaft. Two step-up or step-down transmissions may thus be operated per gearwheel pair by the planetary gearing at the beginning of the drive shaft.

In addition, a rotational direction reversal gearwheel is situated on an auxiliary shaft for the reverse gear. For this purpose, the rotational direction reversal gearwheel simultaneously meshes with the drive gearwheel and the output gearwheel of the reverse gear, whereby the rotational direction reversal is caused. In summary, it can be stated that this six-gear shift transmission having reverse gear can be actuated using only four gearwheel pairs, six forward gears, and one reverse gear and using only two synchronous clutches acting on both sides.

In a further embodiment, in a six-gear shifting system having planetary gearing, a freewheel for the gearwheel pair of the reverse gear is incorporated in the output gearwheel of the reverse gear. This freewheel is only blocked when the reverse gear is engaged, while in all other gears, the freewheel in the output gearwheel of the reverse gear releases the output shaft.

A double clutch can be provided both having typical clutch plates plus contact pressure plate and disengagement bearing or, in a preferred embodiment, the double clutch can have two multi-plate clutches. The double clutch having two multi-plate clutches has the advantage that it has two clutch packs, whose electronic activation can be locked to one another, so that at least only a single one of the two multi-plate clutches releases the associated clutch plate, while the other clutch stage having its clutch pack is engaged.

In a further embodiment, a first synchronous clutch active on both sides is situated on the output shaft, the first synchronous clutch being situated between an output gearwheel of the first and the second gears and an output gearwheel of the reverse gear. A second synchronous clutch active on both sides is additionally provided on the drive shaft between a drive gearwheel of a third and fourth gear and a drive gearwheel of a fifth and sixth gear. In cooperation with the planetary gearing, all six forward gears of the six-gear transmission and also the reverse gear may be shifted in a synchronized manner.

In a further embodiment, the output gearwheel on the output shaft of the first and second gears has a switchable freewheel, which rotates freely when shifting into higher forward gears and when engaging the reverse gear. The output gearwheel of the first and second gears is connected in a rotationally-fixed manner and the freewheel is blocked to the output shaft when shifting into the first gear and when shifting into the second gear. In the event of a shift into the reverse gear, the freewheel is deactivated, so that no force can be transmitted via the drive gearwheel of the first and second gears.

If the output gearwheel of the first and the second gears is equipped with such a freewheel, the first synchronous clutch, which is situated on output shaft, can be implemented as a synchronous clutch active on one side. This has the advantage that further weight may be saved, the output shaft may be shortened further, and the costs may be reduced further. In addition, an output gearwheel that is connected in a rotationally fixed manner to the output shaft meshes with a drive gearwheel of a differential gearing. This drive gearwheel for a differential gearing is connected to a first and a second drive half shaft of the vehicle and transmits the torque of the engine via the transmission and the differential to at least one of the two drive wheels of the respective drive half axle.

### BRIEF DESCRIPTION OF THE DRAWINGS

The present invention will hereinafter be described in conjunction with the following drawing figures, wherein like numerals denote like elements, and.

FIG. 1 shows a schematic sketch of a two-shaft transmission according to a first embodiment;

FIG. 2 shows a schematic sketch of a two-shaft transmission according to a second embodiment; and

FIG. 3 shows a schematic sketch of a multi-shaft transmission having a double clutch according to the prior art.

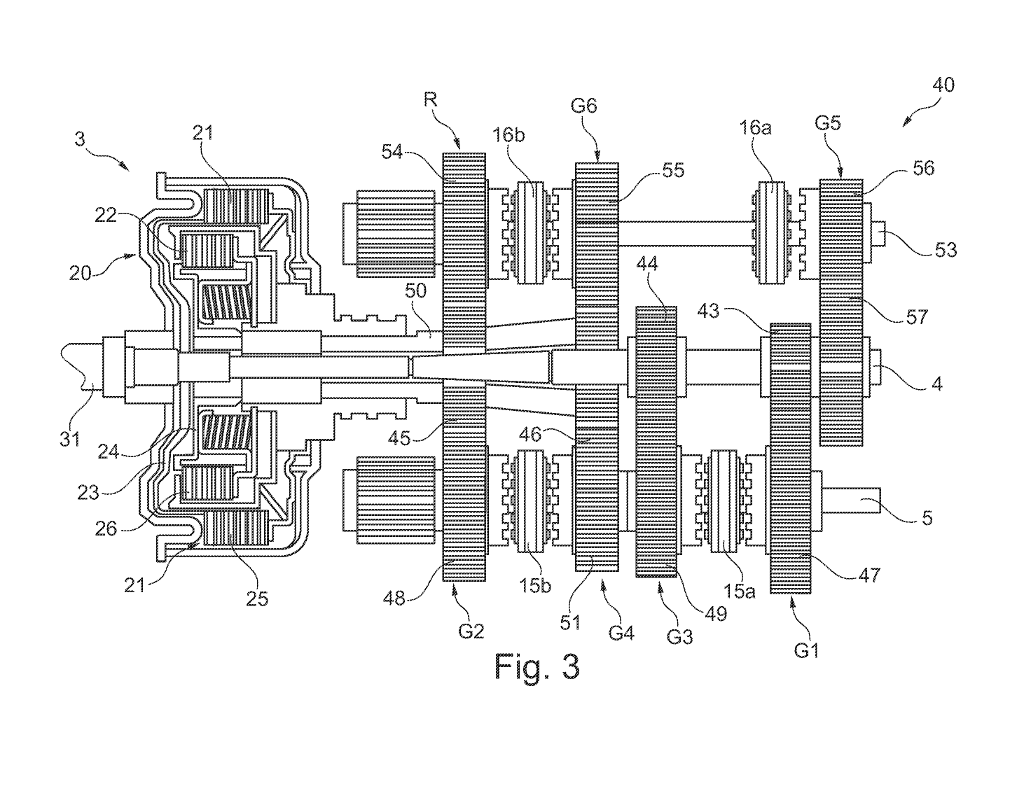

### DETAILED DESCRIPTION

The following detailed description is merely exemplary in nature and is not intended to limit application and uses. Furthermore, there is no intention to be bound by any theory presented in the preceding background or summary or the following detailed description.

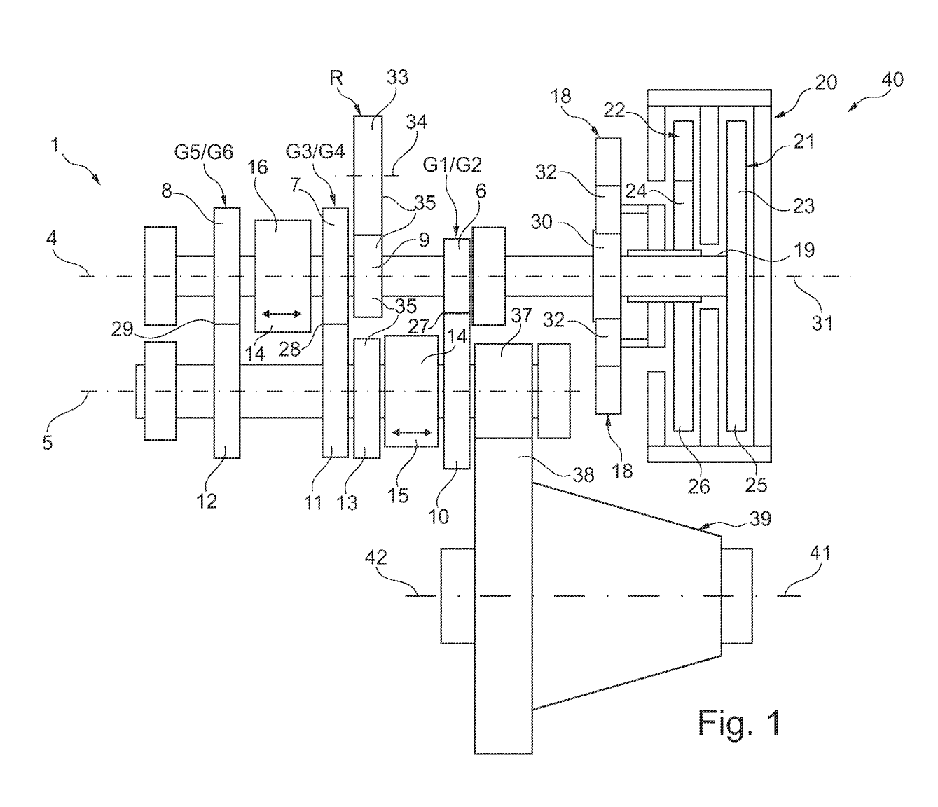

FIG. 1 shows a schematic sketch of a two-shaft transmission 1 according to a first embodiment. The two-shaft transmission 1 is attached to a double clutch 20, which has a first clutch stage 21. Using the first clutch stage 21, an output shaft 31 of a vehicle engine is mechanically connected via a first clutch plate 23 of a first clutch stage 21 to a drive shaft 4 of the six-gear transmission 40 having six forward gears G1 to G6 and one reverse gear R. Not only are drive gearwheels 6 to 9 of the individual gears provided and situated on the drive shaft 4, but rather also a sun wheel 30 of the planetary gearing 18, which is situated on the same end area 19 of the drive shaft 4 as the double clutch 20. A second clutch stage 22 of the double clutch 20 is connected to the planet wheels 32 of the planetary gearing 18 and ensures that the drive torque can be transmitted to the output axle using the three drive gearwheels 6 to 8 of the gears G2, G4, and G6.

Therefore, with the aid of a single drive gearwheel, two different torques and two gears of the six-gear transmission can be transmitted in each case to an output shaft 5. For this purpose, the output shaft 5 only has three output gearwheels 10 to 12 for the forward gears G1 to G6 and one further output gearwheel 13 for the reverse gear R. Therefore, using only three gearwheel pairs 27 to 29, because of the planetary gearing 18 and the double clutch 20, all six forward gears G1 to G6 can be transmitted from the output shaft 31 of the engine via the drive shaft 4 of the transmission and the interposed double clutch 20 to the output shaft 5. In addition, an output gearwheel 37 is situated in a rotationally fixed manner on the output shaft 5, which meshes with the drive gearwheel 38 of a differential gearing 39 and transmits torques to drive half axles 41 and 42 of a vehicle via the differential gearing 39. Fundamentally, transmissions having more than six forward gears may also be conceived in this way.

Only two synchronous clutches 15 and 16 active on both sides are required for shifting between the six forward gears G1 to G6 and the one reverse gear R of the six-gear transmission 40, in this embodiment, a first synchronous clutch 15 being situated on output shaft 5, which can be shifted between the output gearwheel 13 of the reverse gear and the output gearwheel 10 of the first and second forward gears G1 and G2, respectively. Furthermore, a second synchronous clutch is provided on the drive shaft 4, which is situated between the drive gearwheel 7 of the third and fourth gears G3 and G4, respectively, and the drive gearwheel 8 of the fifth and sixth gears G5 and G6, respectively, and alternately engages one of the two drive gearwheels 7 or 8 with the drive shaft 4.

Because of the double clutch 20 in connection with the planetary gearing 18, only two synchronous clutches 15 and 16 and four gearwheel pairs 27, 28, 29, and 35 can thus transmit torques of the six forward gears G1 to G6 and the one reverse gear R to the output gearwheel 37 of the output shaft 5. For the reverse gear, a rotational direction reversal gearwheel 33 is provided on an auxiliary shaft 34, the rotational direction reversal gearwheel 33 meshing with the drive gearwheel 9 and the output gearwheel 13 of the reverse gear R.

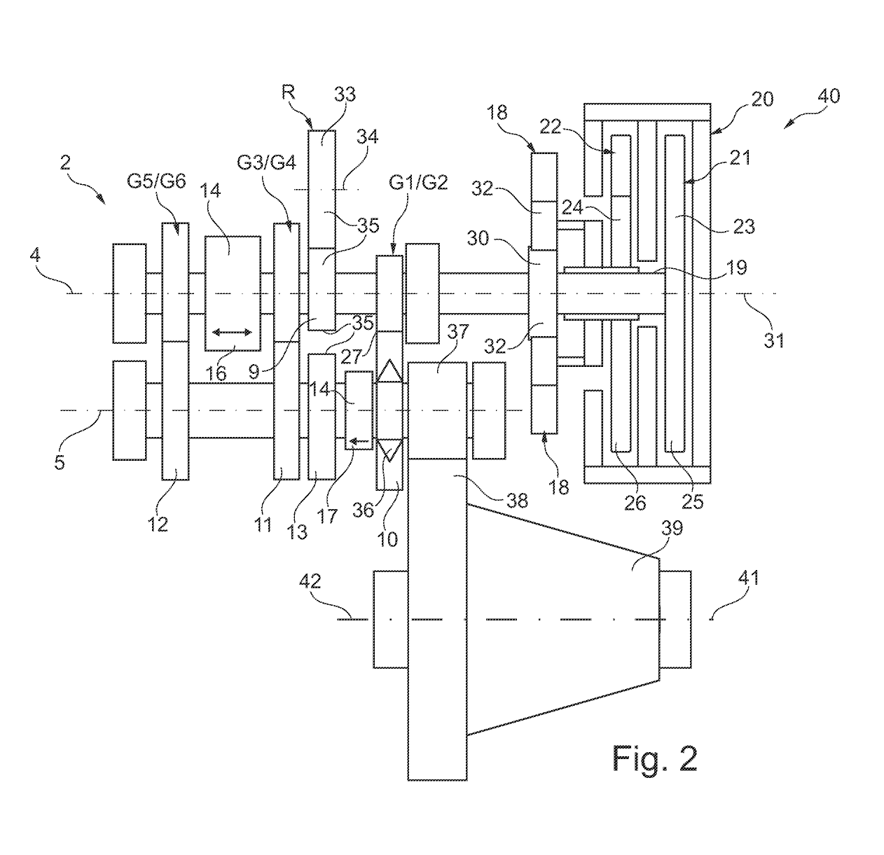

FIG. 2 shows a schematic sketch of a two-shaft transmission 2 according to a second embodiment. Components having identical functions as in FIG. 1 are identified by identical reference numerals and are not explained separately. The difference between the first embodiment according to FIG. 1 and the second embodiment according to FIG. 2 is that the six-gear transmission 40 has provided a switchable freewheel 36 on the output shaft 5 for the output gearwheel 10 of the first and second gears. This freewheel 36 ensures that the output gearwheel 10 is only engaged with the output shaft 5 when the two-shaft transmission 2 is operated in the first or the second gear G1 or G2, respectively, while the freewheel 36 releases the output gearwheel 10 as long as the reverse gear R or a higher forward gear G4 to G6 is engaged. If the reverse gear is engaged, the connection between drive gearwheel and drive shaft is disengaged, so that torque can no longer be transmitted via the freewheel. Because of the freewheel 36 in the output gearwheel 10, only a synchronous clutch 17 active on one side is required for the synchronous clutch 17 between output gearwheel 13 of the reverse gear R and the output gearwheel 10. Not only a space savings but rather also a cost savings in relation to the first embodiment are connected thereto.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A two-shaft shift transmission of a motor vehicle, comprising:
a drive shaft having a first end section;
an output shaft;
a plurality of drive gearwheels for a plurality of forward gears;
a drive gearwheel for a reverse gear situated on the drive shaft;
a plurality of output gearwheels for the plurality of forward gears;
an output gearwheel for the reverse gear situated on the output shaft;
a plurality of synchronous clutches;
a shift element adapted to engage the plurality of drive gearwheels and the drive gearwheel with the plurality of output gearwheels in a plurality of gearwheel pairs via the plurality of synchronous clutches; and
a planetary gearing on the first end section of the drive shaft adapted for engagement via a double clutch with the drive shaft, and the plurality of gearwheel pairs formed of the plurality of drive gearwheels and the plurality of output gearwheels is adapted to transmit a torques of at least two gears of the plurality of forward gears.

2. The two-shaft shift transmission according to claim 1, further comprising:
a first clutch plate adapted to connect a central sun wheel of the planetary gearing to an engine output shaft; and
a first clutch stage adapted to cooperate with the first clutch plate.

3. The two-shaft shift transmission according to claim 2, further comprising:
a second clutch plate adapted to connect a plurality of planet gearwheels of the planetary gearing to the engine output shaft; and
a second clutch stage adapted to cooperate with the second clutch plate.

4. The two-shaft shift transmission according to claim 1, further comprising:
wherein
a rotational direction reversal gearwheel is situated on an auxiliary shaft, the rotational direction reversal gearwheel simultaneously meshing with the drive gearwheel and the output gearwheel of the reverse gear (R).

5. The two-shaft shift transmission according to claim 1, wherein the planetary gearing has two synchronous clutches.

6. The two-shaft shift transmission according to claim 1, wherein the planetary gearing has four gearwheel pairs and a rotational direction reversal wheel.

7. The two-shaft shift transmission according to claim 1, the planetary gearing has a freewheel for a gearwheel pair of the reverse gear.

8. The two-shaft shift transmission according to claim 1, wherein the double clutch has two multi-plate clutches.

9. The two-shaft shift transmission according to claim 1, wherein a first synchronous clutch is situated on the output shaft, the first synchronous clutch situated between the output gearwheel of a first gear and a second gear and the output gearwheel of the reverse gear.

10. The two-shaft shift transmission according to claim 1, wherein a second synchronous clutch is situated on the drive shaft between the drive gearwheel of a third gear and a fourth gear and the drive gearwheel of a fifth gear and a sixth gear.

11. The two-shaft shift transmission according to claim 1, wherein the output gearwheel of a first gear and a second gear comprises a freewheel on the output shaft that is adapted to release when shifting into a higher forward gear and when engaging the reverse gear, and the output gearwheel of the first gear and the second gear is blocked when shifting into the first gear and when shifting into the second gear.

12. The two-shaft shift transmission according to claim 9, wherein the first synchronous clutch is situated on the output shaft and is adapted as a synchronous clutch active on a first side if the output gearwheel of the first gear and the second gear is equipped with a freewheel.

13. The two-shaft shift transmission according to claim 1, wherein the output gearwheel is connected in a rotationally fixed manner to the output shaft and adapted to mesh with the drive gearwheel of a differential gearing.

14. A motor vehicle, comprising:
an engine;
an engine output shaft of the engine;
a first clutch stage;
a planetary gearing comprising a central sun wheel;
a first clutch plate adapted to cooperate with the first clutch stage and connect the central sun wheel of the planetary gearing to the engine output shaft;
a two-shaft shift transmission, comprising:
a drive shaft having a first end section;
an transmission output shaft;
a plurality of drive gearwheels for a plurality of forward gears;
a drive gearwheel for a reverse gear situated on the drive shaft;
a plurality of output gearwheels for the plurality of forward gears;
an output gearwheel for the reverse gear situated on the transmission output shaft;
a plurality of synchronous clutches; and
a shift element adapted to engage the plurality of drive gearwheels and the drive gearwheel with the plurality of output gearwheels in a plurality of gearwheel pairs via the plurality of synchronous clutches,
wherein the planetary gearing on the first end section of the drive shaft adapted for engagement via a double clutch with the drive shaft, and the plurality of gearwheel pairs formed of the plurality of drive gearwheels and the plurality of output gearwheels is adapted to transmit a torques of at least two gears of the plurality of forward gears.

15. The motor vehicle according to claim 14, further comprising a rotational direction reversal gearwheel situated on an auxiliary shaft, the rotational direction reversal gearwheel adapted to simultaneously mesh with the drive gearwheel and the output gearwheel of the reverse gear.

16. The motor vehicle according to claim 14, wherein the planetary gearing has two synchronous clutches.

17. The motor vehicle according to claim 14, wherein the planetary gearing has four gearwheel pairs and a rotational direction reversal wheel.

18. The motor vehicle according to claim 14, wherein the planetary gearing has a freewheel for a gearwheel pair of the reverse gear.

19. The motor vehicle according to claim 14, wherein the double clutch has two multi-plate clutches.

20. The motor vehicle according to claim 14, wherein a first synchronous clutch is situated on the transmission output shaft, the first synchronous clutch situated between the output gearwheel of a first gear and a second gear and the output gearwheel of the reverse gear.
